(19) United States
(12) Patent Application Publication
(10) Pub. No.: US 2020/0342365 A1
(43) Pub. Date: Oct. 29, 2020

(54) System and Method for Changing Travel Reservations

(71) Applicant: Leardi Enterprises, LLC, West Chester, PA (US)

(72) Inventor: Michael LEARDI, West Chester, PA (US)

(21) Appl. No.: 16/853,102

(22) Filed: Apr. 20, 2020

Related U.S. Application Data
(60) Provisional application No. 62/837,480, filed on Apr. 23, 2019.

(51) Int. Cl. G06Q 10/02; G06Q 30/08; G06Q 30/06; G06Q 50/14

(52) U.S. Cl. CPC G06Q 10/025; G06Q 30/08; G06Q 50/14; G06Q 30/0613; G06Q 30/0611

(57) ABSTRACT

A method includes receiving, at a computing device, a first request from a first user device to exchange a first ticket associated with a first passenger. The method further includes identifying, at the computing device, a second passenger associated with a second ticket based on exchange criteria. The method further includes sending a second request for permission to exchange the first ticket with the second ticket to a second user device associated with the second passenger. The method further includes, in response to receiving permission from the second user device initiating exchange of the first ticket from the first passenger to the second passenger and initiating exchange of the second ticket from the second passenger to the first passenger.

### TECHNICAL FIELD

The present disclosure relates to travel reservation systems.

### BACKGROUND

In the modern era, individuals travel around the world. Often such travel is undertaken by way of a vehicle operated by a common carrier, such as an airline, bus company, or railroad company. These common carriers provide service along published routes at published times and an individual may purchase a ticket for a seat to travel along one of the published routes at one of the published times. For example, an individual may purchase a ticket for seat 10C on a particular airline's airplane scheduled to fly from Houston to Atlanta on Jan. 30, 2020 and departing at 5:30 PM.

In some circumstances a traveler may wish to change his or her reservation to a different departure time, but the carrier may have no seats available that match the traveler's criteria. For example, a traveler may wish to take a flight an earlier flight from Houston to Atlanta, but the earlier flight may be sold out. Accordingly, the traveler may not be able to change to the earlier flight through an Airline's ticketing system. Further, exchanging paper tickets with another traveler may not be possible due to laws or regulations, such as Federal Aviation Administration regulations.

### SUMMARY

Systems and methods for changing travel reservations are disclosed. Using the disclosed systems and methods, travelers may communicate directly with each other to arrange and initiate an exchange (e.g., swap) of tickets by a carrier's ticketing system in keeping with applicable laws and regulations. Carriers may include, but are not limited to, airlines, bus companies, and railroad companies. Accordingly, the disclosed systems and methods may benefit travelers by providing an opportunity for the traveler to change travel arrangements that was not previously available to the traveler.

A method includes receiving, at a first user device executing a first instance of an application, first user input requesting exchange of a first ticket associated with a first passenger. The method further includes sending, from the first user device to a server, a first request to exchange the first ticket. The method further includes receiving, at the server, the first request. The method further includes identifying, at the server, a second passenger associated with a second ticket based on exchange criteria. The method further includes sending, from the server to a second user device executing a second instance of the application, a second request for permission to exchange the first ticket with the second ticket, the second user device associated with the second passenger. The method further includes displaying, at the second user device an indication of the second request for permission to exchange the first ticket with the second ticket. The method further includes receiving, at the second user device, second user input indicating permission to exchange the first ticket with the second ticket. The method further includes sending, from the second user device to the server, an indication of the permission to exchange the first ticket with the second ticket. The method further includes, in response to receiving, at the server, the indication of the permission, sending a third request to a ticketing system to change the first ticket from the first passenger to the second passenger and to change the second ticket from the second passenger to the first passenger.

One or more computer readable storage devices store instructions executable by one or more processors to receive, at a first user device executing a first instance of an application, first user input requesting exchange of a first ticket associated with a first passenger. The instructions are further executable by the one or more processors to send, from the first user device to a server, a first request to exchange the first ticket. The instructions are further executable by the one or more processors to receive, at the server, the first request. The instructions are further executable by the one or more processors to identify, at the server, a second passenger associated with a second ticket based on exchange criteria. The instructions are further executable by the one or more processors to send, from the server to a second user device executing a second instance of the application, a second request for permission to exchange the first ticket with the second ticket, the second user device associated with the second passenger. The instructions are further executable by the one or more processors to display, at the second user device an indication of the second request for permission to exchange the first ticket with the second ticket. The instructions are further executable by the one or more processors to receive, at the second user device, second user input indicating permission to exchange the first ticket with the second ticket. The instructions are further executable by the one or more processors to send, from the second user device to the server, an indication of the permission to exchange the first ticket with the second ticket. The instructions are further executable by the one or more processors to, in response to receiving, at the server, the indication of the permission, send a third request to a ticketing system to change the first ticket from the first passenger to the second passenger and to change the second ticket from the second passenger to the first passenger.

A system includes one or more processor devices and one or more memory devices storing instructions. The instructions are executable by the one or more processors to receive, at a first user device executing a first instance of an application, first user input requesting exchange of a first ticket associated with a first passenger. The instructions are further executable by the one or more processors to send, from the first user device to a server, a first request to exchange the first ticket. The instructions are further executable by the one or more processors to receive, at the server, the first request. The instructions are further executable by the one or more processors to identify, at the server, a second passenger associated with a second ticket based on exchange criteria. The instructions are further executable by the one or more processors to send, from the server to a second user device executing a second instance of the application, a second request for permission to exchange the first ticket with the second ticket, the second user device associated with the second passenger. The instructions are further executable by the one or more processors to display, at the second user device an indication of the second request for permission to exchange the first ticket with the second ticket. The instructions are further executable by the one or more processors to receive, at the second user device, second user input indicating permission to exchange the first ticket with the second ticket. The instructions are further executable by the one or more processors to send, from the second user device to the server, an indication of the permission to exchange the first ticket with the second ticket. The instructions are further executable by the one or more processors to, in response to receiving, at the server, the indication of the permission, send a third request to a ticketing system to change the first ticket from the first passenger to the second passenger and to change the second ticket from the second passenger to the first passenger.

### BRIEF DESCRIPTION OF DRAWINGS

For a more complete understanding of this disclosure, reference is now made to the following brief description, taken in connection with the accompanying drawings and detailed description, wherein like reference numerals represent like parts.

FIG. 1 is a block diagram illustrating a system for exchanging tickets;

FIG. 2 is a sequence diagram illustrating operation of the system to exchange tickets;

FIG. 3 is a sequence diagram illustrating operation of the system in response to a counteroffer;

FIG. 4 is a sequence diagram illustrating operation of the system in which an exchange requester is asked to confirm an exchange before the exchange is executed;

FIG. 5 is a sequence diagram illustrating operation of the system in which an offer price is not sent to users asked to exchange tickets;

FIG. 6 is a sequence diagram illustrating operations of the system to support a ticket marketplace for direct exchange of tickets between users;

FIG. 7 is a sequence diagram illustrating operations of the system in which messages between instances of a carrier application are exchange directly rather than through an application service;

FIG. 8 depicts an example GUI screen that prompts a user to attempt to exchange tickets;

FIG. 9 depicts an example GUI screen that displays flights available for ticket switching;

FIG. 10 depicts an example GUI screen that may receive an offer price for a ticket exchange offer;

FIG. 11 depicts an example of a GUI screen that may be displayed to a device that receives a ticket exchange offer;

FIG. 12 depicts an example of a GUI screen that may be displayed to confirm exchange of tickets;

FIG. 13 depicts another example of a GUI screen that may be displayed to confirm exchange of tickets;

FIG. 14 depicts an example of a GUI screen in that may receive a counteroffer price;

FIG. 15 depicts an example of a GUI screen that indicates a counteroffer;

FIG. 16 depicts an example of a GUI screen that prompts a user to confirm an exchange before the exchange is executed;

FIG. 17 depicts an example of a GUI screen that prompts a user who has received a request to exchange tickets may input an offer price;

FIG. 18 depicts an example of a GUI screen through which a user may add a ticket to a marketplace;

FIG. 19 depicts an example of a GUI screen that displays tickets available through the ticket marketplace;

FIG. 20 depicts a flowchart of a method of exchanging tickets; and

FIG. 21 depicts a block diagram of a computing system that may execute the operations and methods described herein.

### DETAILED DESCRIPTION

In the following description, for purposes of explanation, numerous specific details are set forth in order to provide a thorough understanding of the embodiments disclosed herein. It will be apparent, however, to one skilled in the art that the disclosed embodiments may be practiced without these specific details. In other instances, structure and devices are shown in block diagram form in order to avoid obscuring the disclosed embodiments. References to numbers without subscripts or suffixes are understood to reference all instance of subscripts and suffixes corresponding to the referenced number. Moreover, the language used in this disclosure has been principally selected for readability and instructional purposes and may not have been selected to delineate or circumscribe the inventive subject matter. Resort to the claims being necessary to determine such inventive subject matter. Reference in the specification to “one embodiment” or to “an embodiment” means that a particular feature, structure, or characteristic described in connection with the embodiments is included in at least one embodiment.

The terms “a,” “an,” and “the” are not intended to refer to a singular entity, unless explicitly so defined, but include the general class of which a specific example may be used for illustration. The use of the terms “a” or “an” may therefore mean any number that is at least one, including “one,” “one or more,” “at least one,” and “one or more than one.” The term “or” means any of the alternatives and any combination of the alternatives, including all of the alternatives, unless the alternatives are explicitly indicated as mutually exclusive. The phrase “at least one of” when combined with a list of items, means a single item from the list or any combination of items in the list. The phrase does not require all of the listed items unless explicitly so defined.

As used herein, the term “computing device” may refer to a device that includes, but is not limited to a single computer, host, server, laptop, and/or mobile device.

As used herein, the term “network device” may refer to any device that is capable of communicating and transmitting data to another device across any type of network.

As used herein, the term “computing system” may refer to a single electronic computing device or network device that includes, but is not limited to a single computer, virtual machine, virtual container, host, server, laptop, and/or mobile device. The term “computing system may also refer to a plurality of electronic computing devices and/or network devices working together to perform the function described as being performed on or by the computing system.

As used herein, the term “medium” refers to one or more non-transitory physical media that together store the contents described as being stored thereon. Embodiments may include non-volatile secondary storage, read-only memory (ROM), and/or random-access memory (RAM).

As used herein, the term “application” refers to one or more computing modules, programs, processes, workloads, threads and/or a set of computing instructions executed by a computing system. Example embodiments of an application include software modules, software objects, software instances and/or other types of executable code.

Sequences of method steps presented herein are provided as examples and are not meant to be limiting. Thus, methods may be performed in an order alternative to that illustrated in the figures and described herein. To illustrate, a method described as including steps “A” and “B” may be performed with “A” either preceding or following “B,” unless a specific order is indicated.

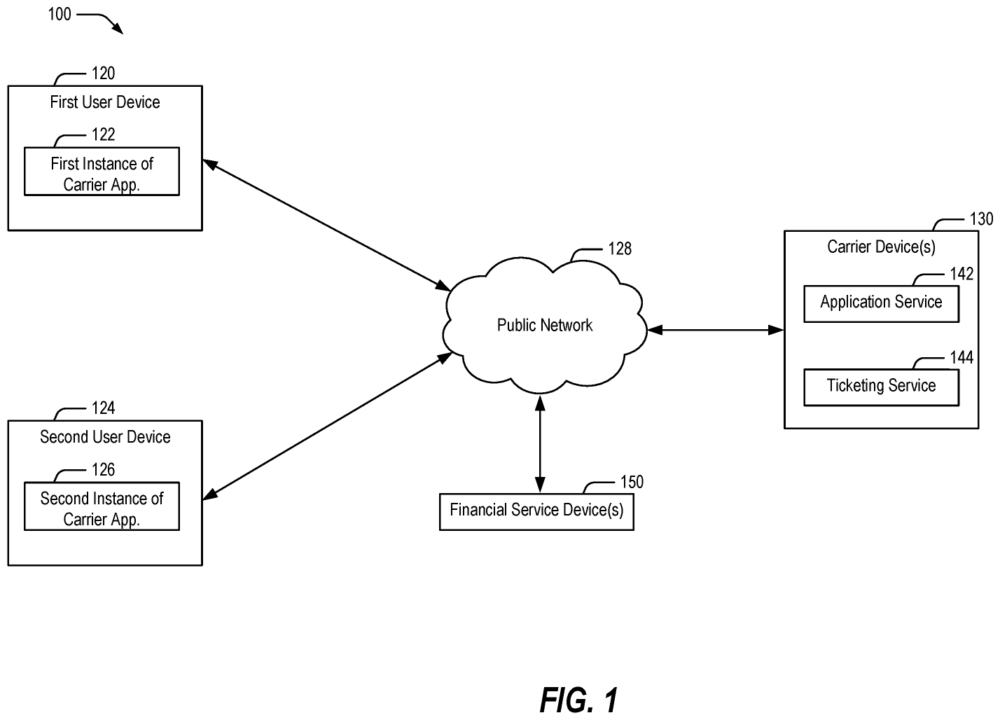

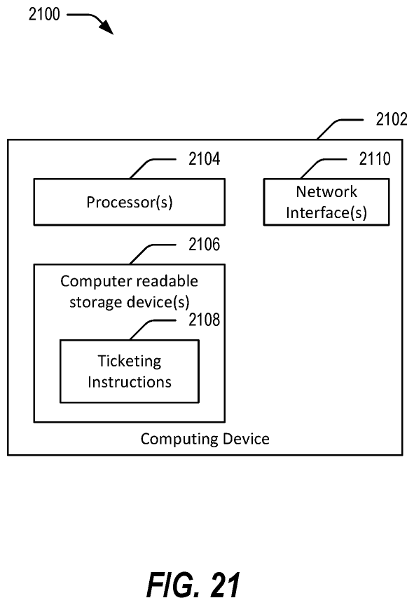

Referring to FIG. 1, a diagram of a system 100 for exchanging tickets is shown. The system 100 includes a first user device 120, a second user device 124, one or more financial service devices 150, and one or more carrier devices 130. The first user device 120, the second user device 124, the one or more financial service devices 150, and the one or more carrier devices 130 include computing devices. Examples of computing devices include mobile computing devices (e.g., mobile phone devices, tablet devices, etc.), desktop computing devices, server devices, etc. An example of a computing device that may correspond to the first user device 120, the second user device 124, a financial service device of the one or more financial service devices 150, or a carrier device of the one or more carrier devices 130 is illustrated in FIG. 21 as described further below. In some implementations, the one or more financial service devices 150, the one or more carrier devices 130, or a combination thereof include computing devices of a cloud computing service provider.

The first user device 120, the second user device 124, the one or more financial service devices 150, and the one or more carrier devices 130 are communicatively coupled to a public network 128 (e.g., the Internet) through one or more wireless and/or wired connections.

The one or more carrier devices 130 are operated by a travel carrier (e.g., an airline, bus company, or railroad company) to provide one or more services to customers. In the illustrated example, the one or more carrier devices 130 execute an application service 142 and a ticketing service 144. It should be noted that the application service 142 and the ticketing service 144 may be executed by distinct or overlapping subsets of the one or more carrier devices 130. The application service 142 is executable by the one or more carrier devices 130 to interact with instances of a carrier application executing on user devices, such as the first user device 120 and the second user device 124. The ticketing service 144 is executable to manage ticket reservations for travelers who are patrons of the travel carrier. The ticketing service 144 may manage the ticket reservations responsive to input from the application service 142, input received via a web interface, input received from an employee terminal, input received from another source, or a combination thereof.

The first user device 120 executes a first instance 122 of the carrier application. The first instance 122 of the carrier application is configured to exchange messages with the application service 142 through the public network 128. For example, the first instance 122 may send ticket reservation requests, flight status requests, airport information requests, and other messages to the application service 142. Similarly, the application service 142 may send reservation confirmations, flight status information, airport information, and other messages to the first instance 122 of the carrier application.

The second user device 124 executes a second instance 126 of the carrier application. The second instance 126 of the carrier application is configured to exchange messages with the application service 142, the ticketing service 144, the first instance 122 of the carrier application, the one or more financial service devices 150, or a combination thereof through the public network 128. In some examples, messages between instances of the carrier application are exchanged through the application service 142.

The one or more financial service devices 150 are associated with one or more financial institutions. The financial institutions may include a bank, a credit card company, another financial institution, or a combination thereof. In an illustrative example, the one or more financial service devices 150 are associated with a financial institution of a user of the first user device 120, a financial institution of a user of the second user device 124, and a financial institution of the carrier associated with the one or more carrier devices 130.

As explained further herein, the system 100 may initiate exchange, by the ticket service 144, of a ticket assigned to the first user of the first user device 120 and a ticket assigned to the second user of the second user device 124 based on messages exchanged by the first instance 122 of the carrier application, the second instance 126 of the carrier application, and the application service 142. Further, the system 100 may initiate financial transactions at the one or more financial service devices 150 based on the ticket exchange.

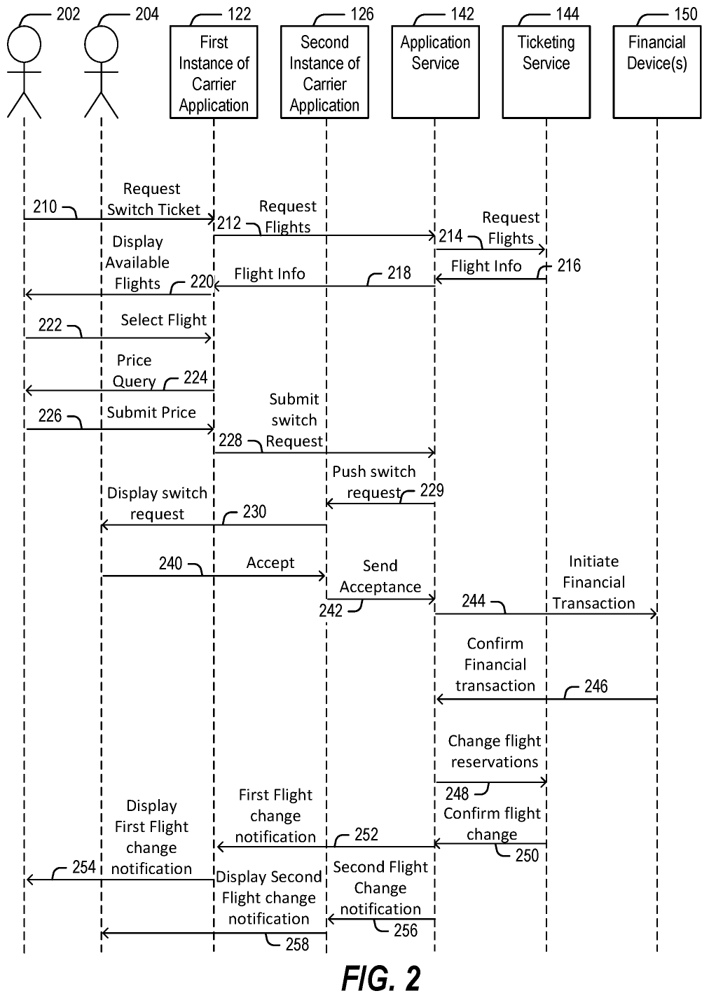

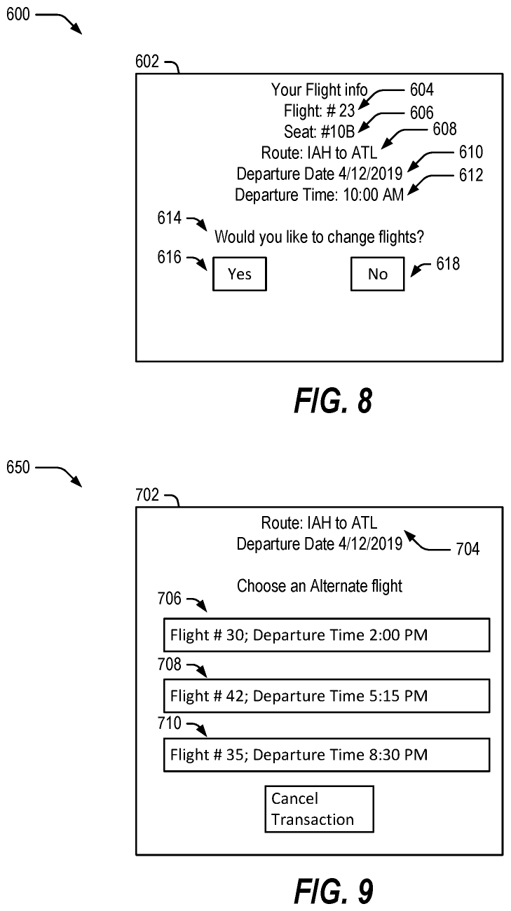

Referring to FIG. 2, a sequence diagram illustrating operation of the system 100 is shown. FIG. 2 illustrates the system 100 exchanging tickets for flights, but the system 100 may be adapted to exchange other types of travel tickets as well. The operations in FIG. 2 illustrate that a user may use the system 100 to offer one or more other users compensation to switch tickets with him/her. In the example illustrated in FIG. 2, the first instance 122 of the carrier application receives a request from a first user 202 of the first user device 120 to switch a ticket through a ticket switching service provided by the carrier application, at 210. For example, the first instance 122 of the carrier application may initiate display, at a display device of the first user device 120, of a graphical user interface (GUI) and the first user 202 may select a GUI element associated with an option to initiate a process for switching a ticket owned by the first user 202 with another user. To illustrate, FIG. 8 depicts an example of a screen 600 of a GUI that may be displayed at the first user device 120.

The screen 600 includes information related to the ticket of the first user 202. In the illustrated example, the information related to the ticket of the first user 202 includes a flight number 604, a seat number 606, a route 608, a departure date 610, and a departure time 612. More information or less information may be displayed. The screen 600 further displays a prompt 614 asking whether the first user 202 would like to change flights. The screen 600 further includes a first selectable element 616 and a second selectable element 618. The first instance 122 of the carrier application may be configured to initiate the ticket switching service in response to receiving a selection of the first selectable element 616 and to refrain from initiating the ticket switching service in response to receiving a selection of the second selectable element 618. Accordingly, receiving a request from the first user 202 of the first user device 120 to switch a ticket through the ticket switching service provided by the carrier application, at 210, may correspond to receiving a selection of the first selectable element 616.

Referring back to FIG. 2, in response to the request to switch a ticket, the first instance 122 of the carrier application sends a request for information about available flights to the application service 142, at 212. The request for information about available flights may include identifying information associated with the first user 202, such as the first user's name, telephone number, an identifier of a user account associated with the first user 202, an identifier of the first instance 122 of the carrier application, an identifier of the ticket held by the first user 202, or a combination thereof. In some examples, the request for information about available flights includes search criteria (e.g., a range of time, a destination, a departure location, etc.). The search criteria may be input by the first user 202, automatically generated by the first instance 122 of the carrier application, or a combination thereof. For example, the first instance 122 of the carrier application may be configured to enforce laws or regulations (e.g., transportation security administration (TSA) regulations) when formulating the search criteria to include in the request for information about available flights. To illustrate, TSA regulations may require that swapped tickets have the same origin and destination airports and be for the same day. Accordingly, the first instance 122 of the carrier application may set the search criteria to search for flights that share a date, origin airport, and destination airport with the ticket owned by the first user 202. The first instance 122 of the carrier application may enforce other rules when formulating the search criteria as well. To illustrate, an airline may prohibit tickets for that airline from being switched with tickets for other airlines. Accordingly, the first instance 122 of the carrier application may set the search criteria to search for flights that share an airline with the ticket owned by the first user 202. In some examples, rules and regulations (e.g., TSA regulations) are enforced by the application service 142, the ticketing service 144, or a combination thereof rather than or in addition to the first instance 122 of the carrier application as explained further below.

In response to the request for information about available flights, the application service 142 sends a query for flight information to the ticketing service 144, at 214. The application service 142 formulates the query based on the search criteria included in the request for information received from the first instance 122 of the carrier application. For example, the application service 142 may repackage the search criteria in the query or may add further search criteria (e.g., based on rules and regulations) further search criteria to the query.

In response to the query for flight information from the application service 142, the ticketing service 144 identifies flight information for flights that match the query. In an illustrative example, the query requests flight information for flights on Jan. 3, 2020. Accordingly, the ticketing service 144 obtains flight information (e.g., flight numbers, departure times, arrival times, origin airport, destination airport, other information, or a combination thereof) for flights departing on Jan. 3, 2020. In some implementations, the ticketing service 144 further enforces rules and regulations. For example, the ticketing service 144 may apply additional search criteria to filter out flight information that does not comply with a rule or regulation. In an illustrative example, the ticketing service 144 filters out flights departing from a different airport than the flight associated with the ticket of the first user 202 based on TSA rules. Further, the ticketing service 144 may filter flight information based on whether passengers have opted into the flight switching service provided by the carrier application. For example, the ticketing service 144 may store or otherwise have access to data identifying users who have opted into the ticket switching service and may filter out flights that do not include any such users when generating results to the query. The ticketing service 144 returns identified flight information to the application service 142, at 216.

The application service 142 then returns the identified flight information to the first instance 122 of the carrier application. In some implementations, the application service 142 filters out flight information based on whether passengers have opted into the flight switching service provided by the carrier application. For example, the application service 142 may store or otherwise have access to data identifying the users who have opted into the ticket switching service and may filter flights that do not include any such users from the flight information received from the ticketing service 144 before returning the flight information to the first instance 122 of the carrier application.

The first instance 122 of the carrier application receives the flight information and updates the GUI of the first user device 120 to display the flight information to the first user 202, at 220. FIG. 9 depicts an example of an updated screen 650 of the GUI of the first user device 120 that displays flight information to the first user 202. The updated screen 650 identifies search criteria 704 used to identify flight information. As explained above, the search criteria 704 may be input by a user, automatically generated by the first instance 122 of the carrier application, automatically generated by the application service 142, automatically generated by the ticketing service 144, or a combination thereof. The updated screen 650 further displays a listing of identified flight information. In the illustrated example, the updated screen 650 includes a first selectable flight element 706 associated with a first flight, a second selectable flight element 708 associated with a second flight, and a third selectable flight element 710 associated with a third flight.

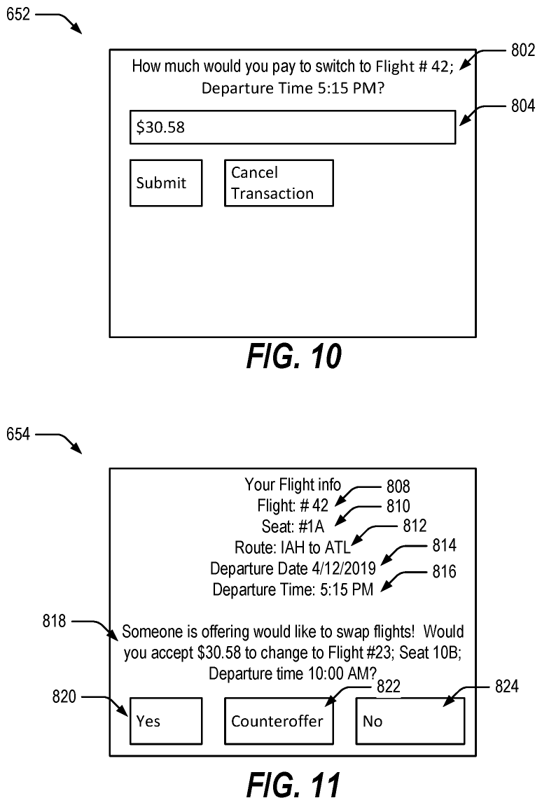

Referring back to FIG. 2, the first instance of the carrier application receives a selection of a GUI element associated with one of the flights, at 222. For example, the first user 202 may select the second selectable flight element 708, associated with a flight #42 between Houston and Atlanta, depicted in FIG. 9. In response to the selection, the first instance 122 of the carrier application updates the GUI of the first user device 120 to display a price query, at 224. The updated GUI is configured to receive input of an offer price in response to the price query. FIG. 10 depicts an example of an updated screen 652 of the GUI of the first user device 120 that displays a price query. In the example illustrated in FIG. 10, the updated GUI displays a price query 802 and an offer price input element 804.

Referring back to FIG. 2, the first instance 122 of the carrier application receives input of an offer price, at 226. For example, the first user 202 may input $30.58 into the offer price input element 804 of FIG. 10. The first instance 122 of the carrier application transmits a switch request, including the offer price, an identifier of the selected flight, and an identifier of the flight for which the first user 202 has a ticket, to the application service 142, at 228. For example, the switch request may identify the flight information of the first user 202, the selected flight #42 between Houston and Atlanta, and the offer price of $30.58.

In response to the switch request, the application service 142 identifies one or more users of the carrier application that have purchased tickets for the particular flight identified by the switch request. The application service 142 may identify which users have purchased tickets for the particular flight based on the flight information received at 216 or may send a further request for identification of passengers of the particular flight. In some examples, the one or more identified users may correspond to users who have opted into the ticket switching service provided by the carrier application. For example, the application service 142 may store or have access to data identifying users who (or instances of the carrier application that) have opted into the ticket switching service. In some implementations, the users may be identified by user account.

The application service 142 pushes (e.g., transmits) a switch request to each instance of the carrier application corresponding to the one or more users identified by the application service 142, at 229. The pushed switch request indicates the offer price and the flight for which the first user 202 has a ticket. The pushed switch request may further indicate the selected flight. In the illustrated example, the application service 142 pushes the switch request to the second instance 126 of the carrier application executing on the second user device 124.

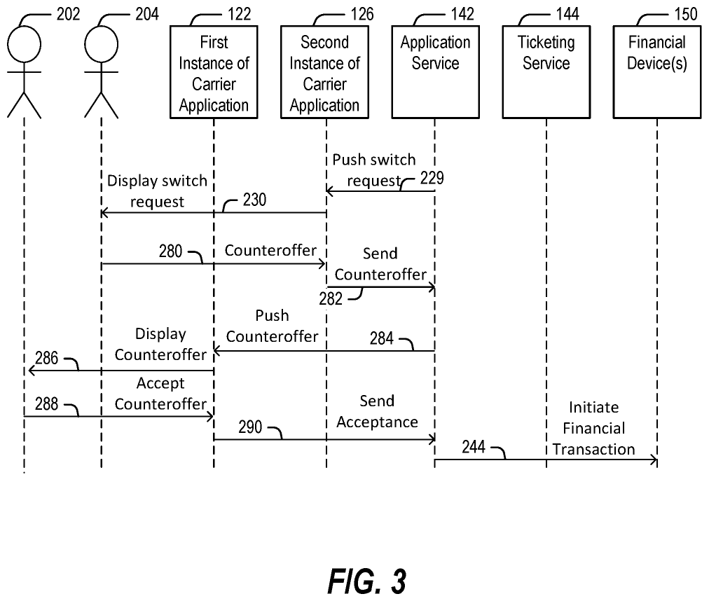

The second instance 126 of the carrier application receives the switch request and updates a GUI displayed at the second user device 124 based on the switch request, at 230. For example, the second instance 126 of the carrier application may cause the second user device 124 to display a message indicating that a user is offering to switch tickets for the offer price. The displayed message may include a description of the ticket (e.g., seat number, flight number, departure time, arrival time, etc.) of the first user 202. FIG. 11 depicts an example of a screen 700 of a GUI of the second user device 124 that displays the switch request. In the example illustrated in FIG. 11, the screen 700 displays information related to the ticket of the second user 204. The information related to the ticket of the second user 204 includes a flight number 808, a seat number 810, a route 812, a departure date 814, and a departure time 816. More information or less information may be displayed. The screen 700 further displays a message 818 indicating that a user is offering to switch tickets with the second user 204 for the offer price (e.g., $30.58). In the illustrated example, the message 818 further includes additional information related to the ticket of the second user 204, such as the flight number 604, the seat number 606, and the departure time 612. The screen 700 further includes a selectable acceptance element 820, a selectable counteroffer element 822, and a selectable rejection element 824. The second instance 126 of the carrier application may receive an indication of acceptance of the switch request (e.g., selection of the selectable acceptance element 820), an indication of rejection of the switch request (e.g., selection of the selectable rejection element 824 or a timeout of the switch request), or an indication of a counter-offer (e.g., selection of the selectable counteroffer element 822) from the second user 204. In the illustrated example of FIG. 2, the second instance 126 of the carrier application receives an indication of acceptance of the switch request, at 240. As described further below, FIG. 3 illustrates example operations that may be performed by the system 100 in response to a counteroffer from the second user 204.

In response to receiving the indication of acceptance, the second instance 126 of the carrier application transmits an acceptance message to the application service 142, at 242. The acceptance message indicates acceptance of the switch request, identifies a ticket owned by the second user 204, identifies the second instance 126, of the carrier application, identifies an account of the second user 204, or a combination thereof.

In response to receiving the acceptance message, the application service 142 sends one or more messages to the one or more financial service devices 150 to initiate one or more financial transactions, at 244. For example, the application service 142 may initiate a transfer of the offer amount from an account of the first user 202 to an account of the second user 204. Further, the application service 142 may initiate a transfer of a flat fee or a portion (e.g., a percentage) of the offer amount from the account of the first user 202 to an account of the airline associated with the tickets.

In response to receiving confirmation of the financial transactions, at 246, the application service 142 sends instructions to the ticketing service 144 to change flight reservations of the first user 202 and the second user 204, at 248. Based on the instructions, the ticketing service 144 assigns the first user's 202 ticket to the second user 204 and assigns the second user's 204 ticket to the first user 202. While not illustrated, it should be noted that in response to receiving a notification that the financial transactions have failed from the one or more financial devices 150, the application service 142 may transmit notifications that the switch has failed to the first instance 122 and the second instance 126 of the carrier application rather than sending instructions to the ticketing service.

In response to successfully changing the flight reservations, the ticketing service 144 sends a flight change confirmation message to the application service 142, at 250. The flight change confirmation message may include confirmation numbers for the new flight reservations, quick response codes (QR Codes®) linked to the tickets, flight times associated with the new flight reservations, seating indicators for the new flight reservations, other information related to the new reservations, or a combination thereof. (QR code is a registered trademark of Denso Wave Inc. of Japan). While not illustrated, in response to failing to change the flight reservations, the ticketing service 144 may return a failure notification to the application service 142. In response to such a failure notification, the application service 142 may instruct the financial devices 150 to reverse the financial transactions carried out and notify the first instance 122 and the second instance 126 of the failure of the flight change.

In response to receiving the flight change confirmation message, the application service 142 transmits a first flight change notification to the first instance 122 of the carrier application, at 252, and a second fight change notification to the second instance 126 of the carrier application, at 256. The first flight change notification includes information regarding the first user's 202 updated flight reservation. For example, the first flight change notification may include a confirmation number for the first user's 202 new reservation, a QR code linked to the first user's 202 new ticket, a flight time associated with the new reservation, a seating indicator for the new reservation, other information related to the new reservation, or a combination thereof. The second flight change notification includes information regarding the second user's 204 updated flight reservation. For example, the second flight change notification may include a confirmation number for the second user's 204 new reservation, a QR code linked to the second user's 204 new ticket, a flight time associated with the new reservation, a seating indicator for the new reservation, other information related to the new reservation, or a combination thereof.

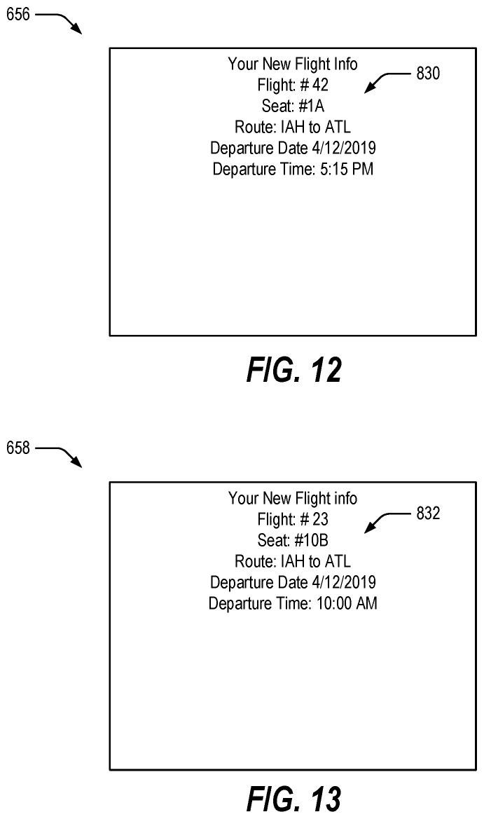

In response to receiving the first flight change notification, the first instance 122 of the carrier application updates the GUI of the first user device 120 to display an indicator of the first flight change notification, at 254. FIG. 12 depicts an example of an updated screen 656 of the GUI of the first user device 120 that displays the first flight change notification. In the example shown in FIG. 12, the updated screen 656 includes updated flight information 830 for the first user 202. Referring back to FIG. 2, in response to receiving the second flight change notification, the second instance 126 of the carrier application updates the GUI of the second user device 124 to display an indicator of the second flight change notification, at 258. FIG. 13 depicts an example of an updated screen 658 of the GUI of the second user device 124 that displays the second flight change notification. In the example shown in FIG. 13, the updated screen 658 includes updated flight information 832 for the second user 204.

While not depicted in FIG. 2, after pushing the switch request, at 229, the application service 142 may transmit a message to the first instance 122 of the carrier application in response to determining that no acceptance has been received within a timeout period. In response to such a message, the first instance 122 of the carrier application may update the GUI displayed at the first user device 120 to request input of a higher acceptance price. The first instance 122 of the carrier application may transmit any input acceptance price to the application service 142, as illustrated at 228.

Thus, FIG. 2 illustrates operation of the system 100 to directly exchange tickets between passengers. As described above, the system 100 may enforce rules or regulations (e.g., TSA regulations). In some examples, actions depicted in FIG. 2 may be combined and/or performed in a different sequence. For example, the application service 142 may request that the ticketing service 144 change the flight reservations, at 248, and initiate the financial transactions, at 244, in response to receiving the confirmation of the flight change confirmation message, at 250. Further, the application service 142 may send the first flight change notification, at 252, and the second flight change notification, at 256, in response to the confirmation of the financial transactions received from the one or more financial devices 150, at 246.

Referring to FIG. 3, example operations that may be performed by the system 100 in response to a counter-offer from the second user 204 are shown. As explained above with reference to FIG. 2, in response to receiving the pushed switch request, at 229, the second instance 126 of the carrier application updates a GUI displayed at the second user device 124 based on the switch request, at 230. For example, the second instance 126 of the carrier application may cause the second user device 124 to display the message 818 indicating that a user is offering to switch tickets with the second user 204 for the offer price (e.g., $30.58) as depicted in FIG. 11.

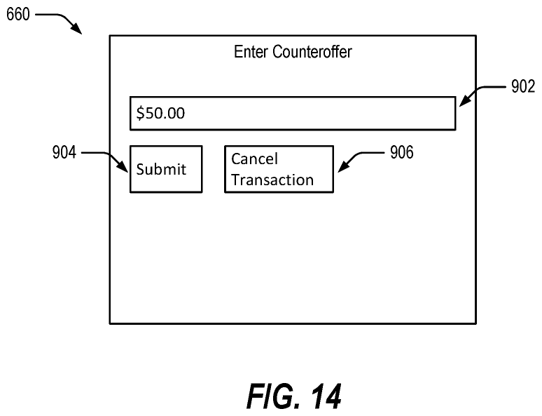

In the example, illustrated in FIG. 3, the second instance 126 of the carrier application receives input indicating a counteroffer, at 280. The input indicating the counteroffer includes a counteroffer price. For example, the second user 204 may select the selectable counteroffer element 822. In response to the selection of the selectable counteroffer element 822, the second instance 126 of the carrier application may update the GUI of the second user device 124 to display a counteroffer price input screen. FIG. 14 depicts an example of a counteroffer input screen 660. In the example of FIG. 14, the counteroffer input screen 660 includes a counteroffer price element 902 configured to receive input of the counteroffer price, a counteroffer submission element 904, and a counteroffer cancellation element 906. For example, the input indicating the counteroffer may correspond to the second user 204 inputting a counteroffer price (e.g., $50.00) through counteroffer price element 902 and selecting the counteroffer submission element 904.

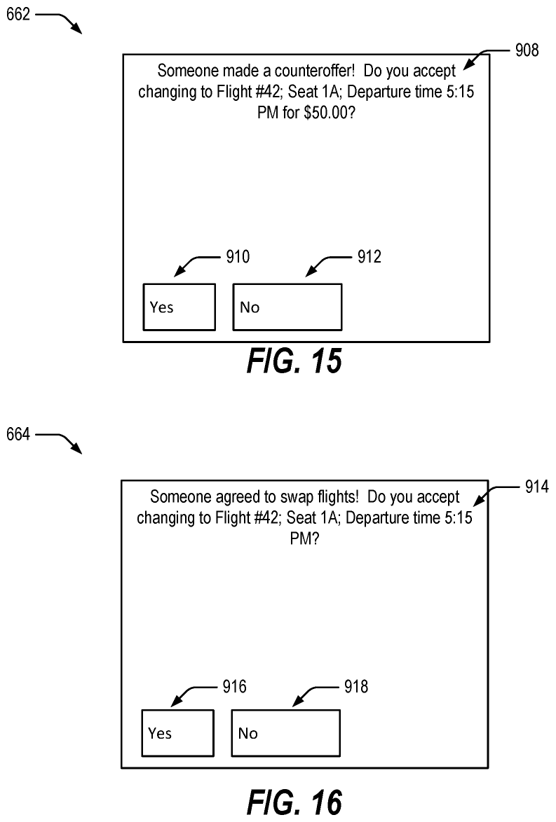

Referring to FIG. 3, the second instance 126 transmits a message indicating the counteroffer to the application service 142, at 282. The message indicating the counteroffer includes an indication of the counteroffer price (e.g., $50). The application service 142 pushes the counteroffer price to the first instance 122 of the carrier application, at 284. In response to receiving the counteroffer price, the first instance 122 of the carrier application updates the GUI displayed at the first user device 120 to display the counteroffer price, at 286. FIG. 15 depicts an example of an updated screen 662 of the GUI of the first user device 120 that displays the counteroffer price. In the example of FIG. 15, the updated screen 656 includes a counteroffer message 908 indicating the counteroffer price (e.g., $50.00). In the example of FIG. 15, the updated screen 656 further includes a selectable counteroffer acceptance element 910 and a selectable counteroffer rejection element 912.

In the illustrated example of FIG. 3, the second instance 126 of the carrier application receives an indication of acceptance of the counteroffer price, at 288. For example, the first user 202 may select the selectable counteroffer acceptance element 910 of FIG. 10. In response to receiving the indication of acceptance of the counteroffer price, the first instance 122 of the carrier application sends a message indicating the acceptance of the counteroffer price to the application service 142, at 290. In response to receiving the message indicating the acceptance of the counteroffer price, the application service 142 initiates the one or more financial transactions, at 244, using the counteroffer price instead of the offer price and proceeds as described above with reference to FIG. 2.

While not illustrated in FIG. 3, in response to receiving an indication that the first user 202 rejects the counter offer price (e.g., a selection of the selectable counter offer rejection element 912), the first instance 122 of the carrier application may transmit an indication of the rejection to the application service 142 and the application service 142 may push an indication of the rejection to the second instance 126 of the carrier application for display.

Thus, FIG. 3 illustrates that the system 100 may support counter offers. It should be noted that in some implementations, the system 100 may support counter counteroffers etc. For example, the updated screen 662 of the GUI of the first user device 120 that displays the counteroffer price depicted in FIG. 15 may further include a counter counteroffer input element. The application service 142 may relay a received counter counteroffer to the second instance 126 of the carrier application and so on. Thus, the system 100 may support negotiation of ticket switching price.

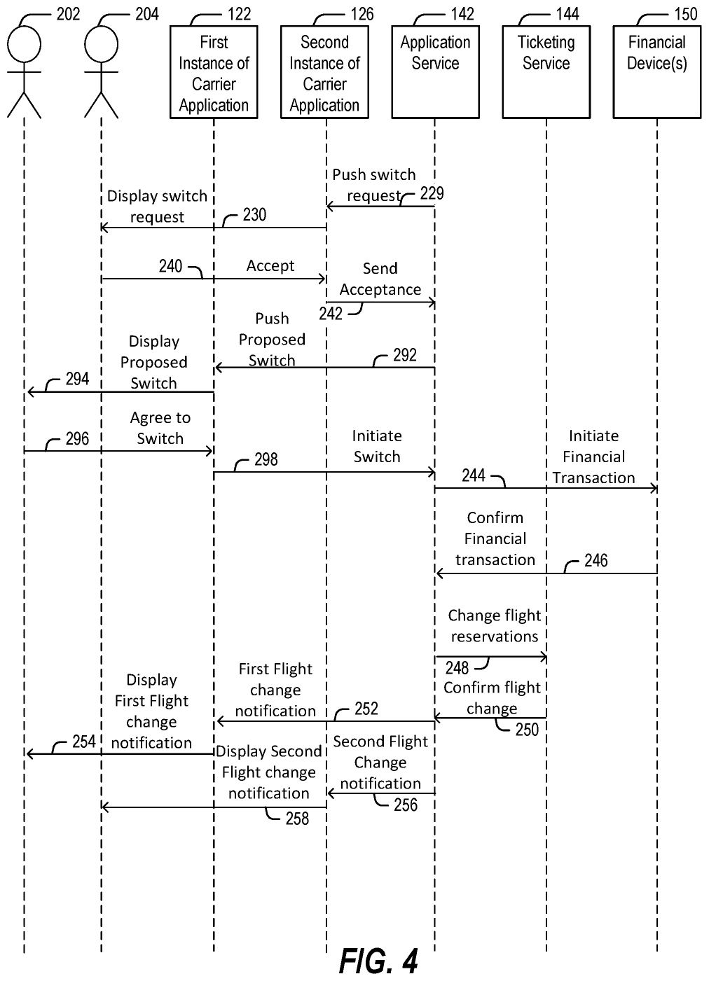

Referring to FIG. 4, another example of operations that may be performed by the system 100 to exchange tickets between users is shown. In particular, the operations depicted in FIG. 3 show that in response to receiving an acceptance message indicating that the second user 204 agrees to switch his/her ticket with the first user 202, the application service 142 may request that the first user 202 agree to take the ticket of the second user 204. As explained above with reference to FIG. 2, the application service 142 may receive an acceptance message, at 242, indicating that the second user 204 agrees to switch tickets with the first user 202 for the offer price. In response to the acceptance message, the application service 142 pushes a proposed switch notification to the first instance 122 of the carrier application, at 292. The proposed switch notification includes information associated with a proposed switch of the ticket of the first user 202 and the ticket of the second user 204. For example, the proposed switch notification may identify a seat number, a departure time, an arrival time, etc. associated with the ticket of the second user 204.

In response to the proposed switch notification, the first instance 122 of the carrier application updates the GUI of the first user device 120 to display information describing the proposed switch, at 294. The updated GUI includes information associated with the ticket of the second user 204. The updated GUI further includes GUI elements configured to accept or reject the ticket of the second user 204. FIG. 16 depicts an example of an updated screen 664 of the GUI of the first user device 120 that displays information describing a proposed switch. For example, the updated GUI may indicate that the second user has agreed to switch tickets with the first user 202 for the offer price and that the ticket of the second user 204 is associated with a seat 33C. The updated GUI may further include selectable elements for accepting or rejecting the ticket of the second user 204. Accordingly, the first user 202 may confirm that a ticket meets his/her expectations before a switch is executed.

In response to receiving input indicating that the first user 202 agrees to the proposed switch, at 296, the first instance 122 of the carrier application may send instructions to the application service 142 to initiate the proposed switch, at 298. In response to the instructions to initiate the proposed switch, the application service 142 may initiate the one or more financial transactions, at 244, and continue as described above with respect to FIG. 2.

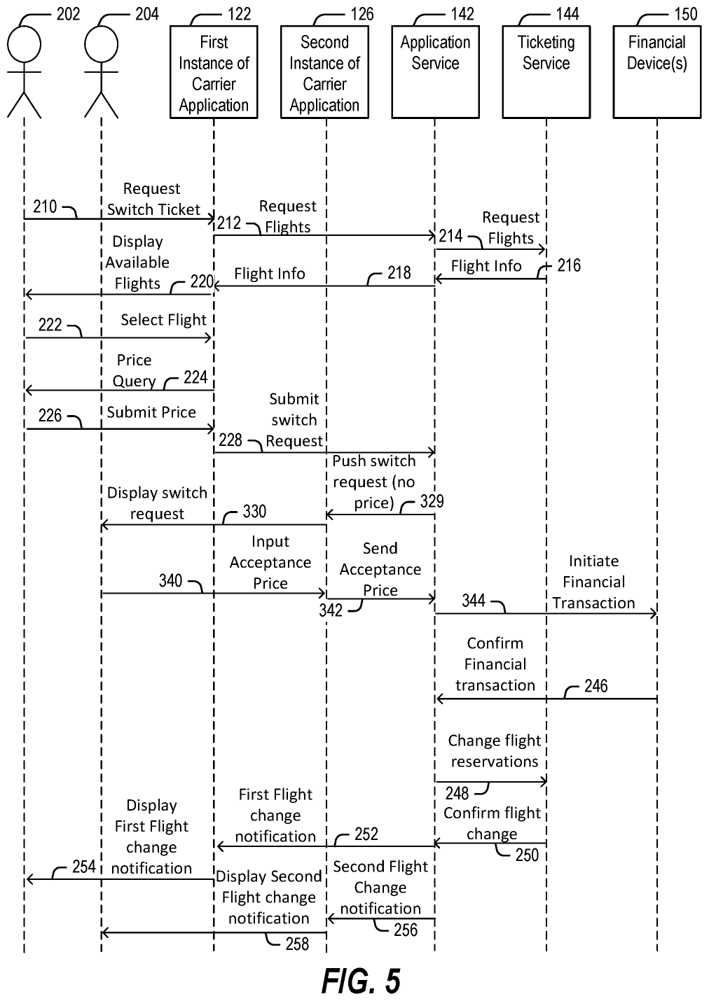

Referring to FIG. 5, an alternative example of operations that may be performed by the system 100 to exchange tickets between passengers is shown. In particular, FIG. 5 illustrates an example in which a passenger wanting to exchange tickets inputs an offer price he/she is willing to pay but the system 100 does not publish the price to other users. Instead, the system 100 solicits bids from other users and determines whether any of the bids satisfies the offer price. The operations depicted in FIG. 5 are the same as those depicted in FIG. 2 until the application service 142 receives the switch request, including the offer price, the identifier of the selected flight, and the identifier of the flight for which the first user 202 has a ticket, at 228. In response to the switch request, the application service 142 identifies one or more users of the carrier application that have purchased tickets for the particular flight identified by the switch request. The application service 142 may identify which users have purchased tickets for the particular flight based on the flight information received at 216 or may send a further request for identification of passengers of the particular flight. In some examples, the one or more identified users may correspond to users who have opted into the ticket switching service provided by the carrier application. For example, the application service 142 may store or have access to data identifying users who (or instances of the carrier application that) have opted into the ticket switching service. In some implementations, the users may be identified by user account.

The application service 142 pushes (e.g., transmits) a switch request to each instance of the carrier application corresponding to the one or more users identified by the application service 142, at 329. The pushed switch request indicates the flight for which the first user 202 has a ticket but does not indicate the offer price. The pushed switch request may further indicate the selected flight. In the illustrated example of FIG. 5, the application service 142 pushes the switch request to the second instance 126 of the carrier application executing on the second user device 124.

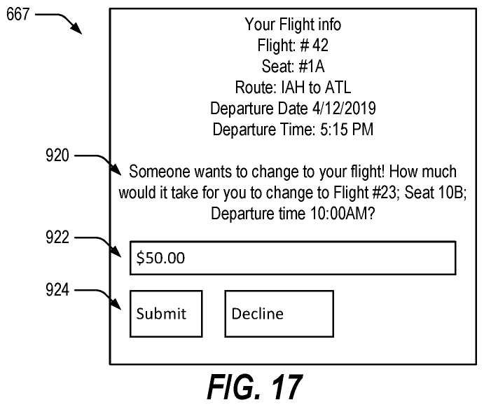

The second instance 126 of the carrier application receives the switch request and updates a GUI displayed at the second user device 124 based on the switch request, at 330. For example, the second instance 126 of the carrier application may cause the second user device 124 to display a message indicating that a user is offering to switch tickets (without indicating the offer price) and a GUI element configured to receive input of an offer. The displayed message may include a description of the ticket (e.g., seat number, flight number, departure time, arrival time, etc.) of the first user 202. FIG. 17 depicts an example of a screen 667 of the GUI of the second user device 124 that displays a message 920 indicating that a user wants to switch to a flight for which the second user 204 has a ticket. The screen 667 further includes an offer price input element 922 and a selectable offer price submission element 924.

Referring back to FIG. 5, the second instance 126 of the carrier application receives input indicating an acceptance price, at 340. The acceptance price received by the second instance 126 of the carrier application indicates a monetary amount for which the second user 204 is willing to exchange his/her ticket for the ticket of the first user 202. For example, the second instance 126 of the carrier application may receive input indicating that the second user 204 is willing to exchange his/her ticket for the ticket of the first user 202 for $50.00. In an illustrative example, the input indicating that the second user is willing to exchange his/her ticket for the ticket of the first user 202 for $50 may correspond to the second user 204 enter “$50.00” into the offer price input element 922 and selecting the selectable offer price submission element 924.

In response to receiving the input indicating the acceptance price, the second instance 126 transmits the acceptance price to the application service 142, at 342. In response to determining that the acceptance price satisfies (e.g., is less than or equal to) the offer price, the application service 142 sends one or more messages to the one or more financial service devices 150 to initiate one or more financial transactions, at 344. For example, the application service 142 may initiate a transfer of the acceptance amount from an account of the first user 202 to an account of the second user 204. Further, the application service 142 may initiate a transfer of a flat fee or a portion (e.g., a percentage) of the acceptance amount from the account of the first user 202 to an account of the airline associated with the tickets. The operations continue as described above with respect to FIG. 2. While not depicted, after pushing the switch request, at 229, the application service 142 may transmit a message to the first instance 122 of the carrier application in response to determining that no acceptance price that satisfies the offer price has been received within a timeout period. In response to such a message, the first instance 122 of the carrier application may update the GUI displayed at the first user device 120 to request input of a higher acceptance price. The first instance 122 of the carrier application may transmit any input acceptance price to the application service 142, as illustrated at 228.

It should be noted that the application service 142 may receive acceptance prices from more than one instance of the carrier application. For example, in addition to receiving the acceptance price from the second instance 126 of the carrier application, at 342, the application service 142 may receive an acceptance price from a third instance of the carrier application executed by a third user device that received the switch request pushed by the application service 142, at 229. In situations in which more than one received acceptance price satisfies the offer price, the application service 142 may select an acceptance price based on time received (e.g., select first acceptance price that satisfies offer price), based on value (e.g., select a lowest received acceptance price), or a combination thereof. The application service 142 may initiate a switch of the ticket of the first user 202 and a ticket associated with the selected acceptance price as described herein.

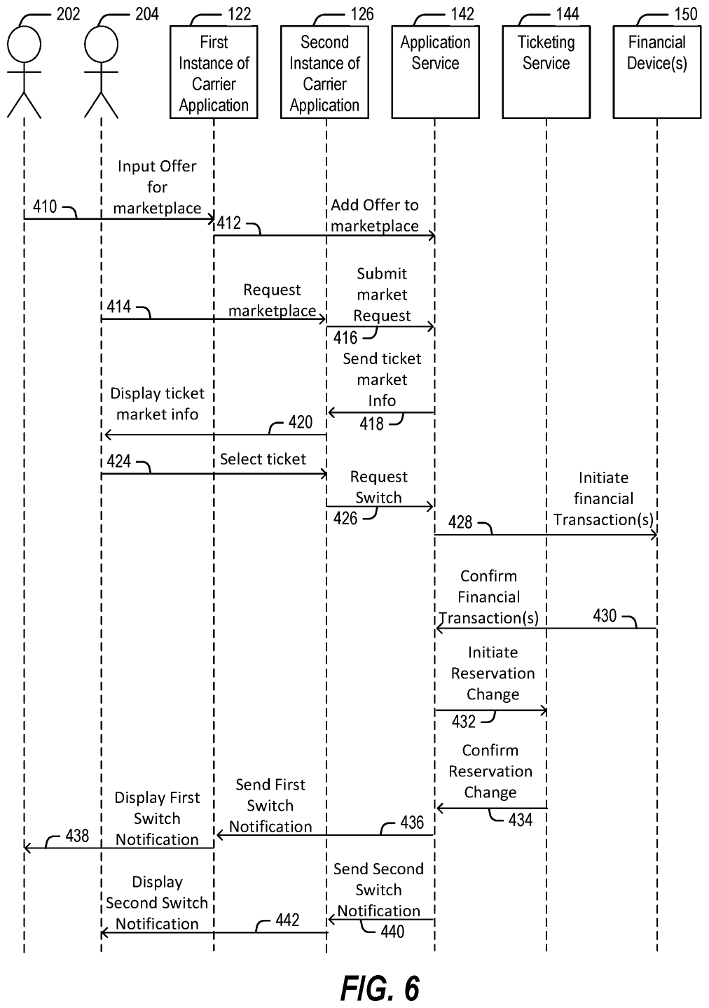

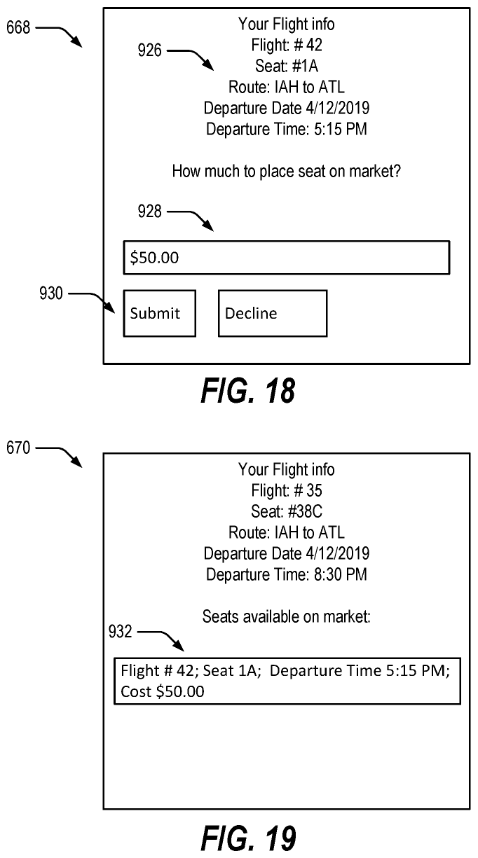

Referring to FIG. 6, an alternative example of operations that may be performed by the system 100 to exchange tickets between passengers is shown. The operations in FIG. 6 illustrate that a user may use the system 100 to place an offer to switch his/her ticket on a marketplace that others may browse. In FIG. 6, the first instance 122 of the carrier application receives user input requesting to add an offer to switch his/her ticket to the marketplace, at 410. The offer may identify a particular ticket, an offer price, or a combination thereof. For example, the first user 202 may input an offer to switch his/her ticket with someone who pays him/her $50. FIG. 18 depicts an example of a screen 668 that may be displayed by the GUI of the first user device 120 and is configured to receive input requesting to add an offer to switch a ticket to a marketplace. The screen 668 displays information 926 associated with a ticket of the first user 202. The ticket may be selected on a previous screen. The screen 668 further includes a marketplace offer price input element 928 and a selectable marketplace submission element 930. Receiving the user input requesting to add an offer to switch a ticket to the marketplace, at 410, may include receiving the offer price in the marketplace offer price input element 928 and a selection of the selectable marketplace submission element 930.

Referring back to FIG. 6, in response to receiving the input requesting to add an offer to switch a ticket to the marketplace, the first instance 122 of the carrier application sends a message to the application service 142 indicating that the offer is to be added to a marketplace, at 412. For example, the first instance 122 of the carrier application may send instructions to the application service 142 instructing the application service to add an entry to an online marketplace indicating that the ticket of the first user 202 is available for switching for $50. The application service 142 may maintain listings of the marketplace in a database stored locally at the one or more carrier devices 130 or remotely.

The second instance 126 of the carrier application receives a request to view a ticket switching marketplace, at 414. The request to view the ticket switching marketplace may include search criteria (e.g., a price, price range, departure time, etc.). For example, the second user 204 may input, through a GUI displayed at the second user device 124, a request to see a listing of tickets available for switching that are for flights that depart after 3:30 pm.

In response to receiving the request to view the ticket switching marketplace, the second instance 126 of the carrier application submits a market request to the application service, at 142. The market request may include data associated with a ticket of the second user 204 (e.g., a reservation number, a flight number, a seat number, a departure airport, a destination airport, a travel date, etc.) and any search criteria included in the request to view the ticket switching marketplace. Further, the second instance 126 of the carrier application may add search criteria to the market request based on laws, rules, or regulations. For example, based on TSA regulations, the second instance 126 of the carrier application may add search criteria to the market request to limit results to tickets for flights departing from the same airport and on the same day as a flight for which the second user 204 has a ticket.

In response to the market request, the application service 142 sends ticket market information to the second instance 126 of the carrier application, at 418. The ticket market information includes information identifying tickets (e.g., flight number, departure time, arrival time, departure airport, destination airport, other information, or a combination thereof) available for switching and associated offer prices. For example, the ticket market information may include data indicating that the ticket of the first user 202 is available for switching for a price of $30. The application service 142 may filter ticket market information provided to the second instance 126 of the carrier application based on any search criteria included in the market request. For example, in response to the market request requesting tickets for flights that depart after 3:30 pm, the application service 142 may exclude data related to tickets for flights that depart before 3:30 pm from the ticket market information. In some implementations, the application service 142 further filters the market information based on laws, rules, or regulations. For example, based on TSA regulations, the application service 142 may exclude from the ticket market information data related to tickets for a different departure day, a different destination, a different departure airport, etc. than a ticket of the second user 204. Thus, rules and regulations (e.g., TSA regulations) may be enforced by the carrier application (e.g., the second instance 126 of the carrier application), the application service 142, or a combination thereof.

The second instance 126 of the carrier application receives the ticket market information and updates the GUI of the second user device 124 based on the ticket market information, at 420. For example, the second instance 126 of the carrier application may update the GUI of the second user device 124 to indicate that the ticket of the first user 202 is available for switching for a price of $50. FIG. 19 depicts an example of a screen 670 of the GUI of the second user device 124 that indicates that a ticket is available for switching for a price. The screen 670 includes a selectable market listing element 932. The selectable market listing element 932 includes the offer price (e.g., $50) and a display of some or all of the information 926 associated with the ticket of the first user 202.

Referring back to FIG. 6, the second instance 126 of the carrier application receives a selection of a ticket displayed in the GUI of the second user device 124, at 424. For example, the second user 204 may select the selectable market listing element 932 corresponding to the ticket of the first user 202. In response to receiving the selection, the second instance 126 of the carrier application sends a request to switch tickets to the application service 142, at 426. The request to switch tickets identifies tickets to be exchanged (e.g., the ticket selected by the second user 204 and the ticket owned by the second user 204).

In response to the request to switch tickets, the application service 142 sends one or more messages to initiate one or more financial transactions at the one or more financial devices 150, at 428. The one or more financial transactions transfer the offer price (e.g., $30) from an account of the second user 204 to an account of the first user 202. Further, the one or more financial transactions may transfer a fee (e.g., a flat fee or a percentage of the offer price) from an account of the second user 204 to an account of the airline associated with the tickets to be exchanged.

The application service 142 receives one or more confirmations of the one or more financial transactions, at 430. In response to receiving the one or more confirmations, the application service 142 instructs the ticketing service 144 to switch the tickets to be exchanged between the first user 202 and the second user 204, at 432. While not illustrated, it should be noted that the application service 142 may be configured to send a notification to one or both of the first instance 122 and the second instance 126 in response to receiving an indication from the one or more financial devices 150 that the one or more financial transactions have failed.

In response to the instructions to switch the tickets, the ticketing service 144 changes reservations of the first user 202 and the second user 204 so that the ticket previously assigned to the first user 202 is assigned to the second user 204 and the ticket previously assigned to the second user 204 is assigned to the first user 202 and sends a confirmation of the reservation changes to the application service 142, at 434. In response to the confirmation of the reservation changes, the application service 142 sends a first switch notification to the first instance 122 of the carrier application, at 436, and a second switch notification to the second instance 126 of the carrier application, at 440. The first switch notification may include information (e.g., flight number, confirmation number, departure time, arrival time, other information, or a combination thereof) regarding the first user's 202 new reservation.

The first instance 122 of the carrier application updates the GUI displayed at the first user device 120 based on the first switch notification, at 438, to indicate that the first user 202 has a new reservation. The second switch notification may include information (e.g., flight number, confirmation number, departure time, arrival time, other information, or a combination thereof) regarding the second user's 204 new reservation. The second instance 126 of the carrier application updates the GUI displayed at the second user device 124 based on the second switch notification, at 442, to indicate that the first user 202 has a new reservation.

Thus, FIG. 6 illustrates operations the system 100 may perform to provide a user an online marketplace on which to offer his/her ticket for ticket switching. It should be noted that the system 100 may operate according to the operations illustrated in one of the FIGS. 2-6 based on input received at the carrier application. Thus, the system 100 may support a variety of techniques for directly exchanging travel tickets.

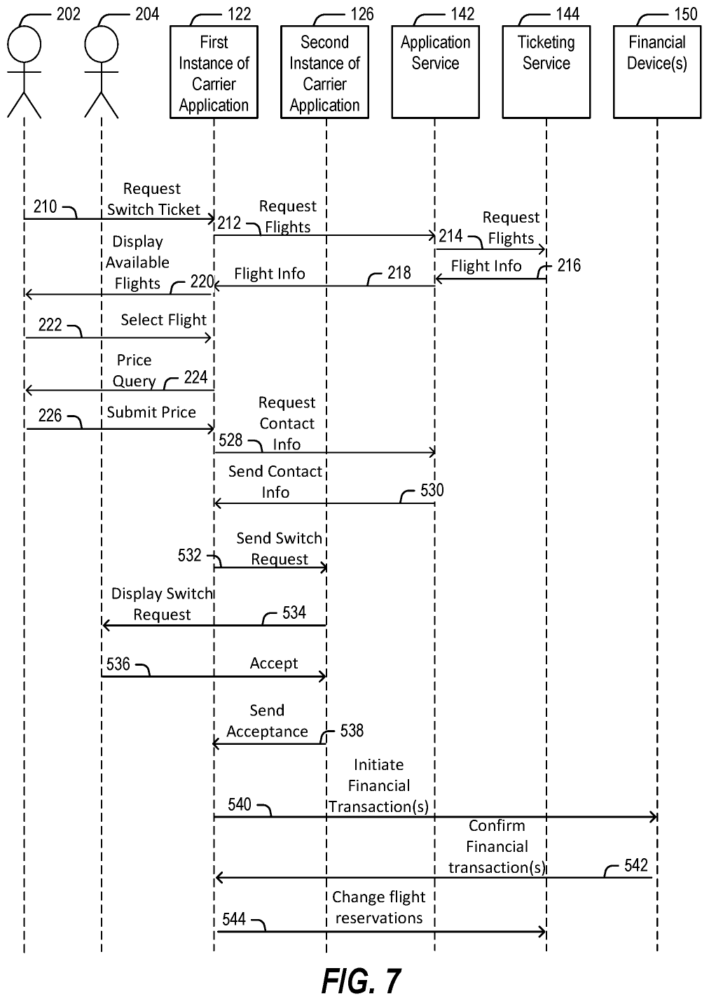

Operations depicted in FIGS. 2-6 may be allocated between components of the system 100 differently than illustrated. FIG. 7 depicts an example in which an instance of the carrier application messages other instances of the carrier application directly rather than relying on the application service 142 to push messages to other instances of the carrier application.

In the example illustrated in FIG. 7, in response to receiving the input of the offer price, at 226, the first instance 122 of the carrier application requests that the application service 142 identify contact information for users that have tickets that may be switched, at 528. The request to identify contact information may include search criteria. The search criteria may include criteria received via the GUI of the first user device 120 as well as automatically generated criteria. The automatically generated criteria may be generated by the first instance 122 of the carrier application based on user preferences, government regulations, other properties, or a combination thereof. For example, based on TSA regulations, the automatically generated search criteria may include a travel date associated with the ticket of the first user 202, a destination airport associated with the ticket of the first user 202, a departure airport associated with the ticket of the first user 202, or a combination thereof.

In response to the request to identify contact information, the application service 142 identifies contact information associated with users that have tickets that may be switched. A user's contact information may include a network address (e.g., an internet protocol address) associated with an instance of the carrier application associated with the user. The contact information may be filtered based on any search criteria included in the request. Further, the application service 142 may filter the contact information based on rules or regulations (e.g., TSA regulations). Thus, regulations (e.g., TSA regulations) may be enforced by the first instance 122 of the carrier application, by the application service 142, or by a combination thereof. In some implementations, the application service 142 queries the ticketing service 144 to receive data indicating passengers who have tickets for flights that satisfy the search criteria (and any other filter rules). The application service 142 may maintain a database of user contact information corresponding to users who have opted into the ticket switching service provided by the system 100. The application service 142 may identify the contact information associated with users that have tickets that may be switched based on the database and based on the data from the ticketing service 144.

The application service 142 sends the identified contact information to the first instance 122 of the carrier application, at 530. Based on the identified contact information, the first instance 122 of the carrier application sends switch requests to other instances of the carrier application. In the illustrated example, the first instance 122 of the carrier application sends a switch request to the second instance 126 of the carrier application, at 532. The switch request includes information (e.g., flight number, departure time, arrival time, seat number, other information, or a combination thereof) associated with the ticket of the first user 202 and the offer price.

The second instance 126 of the carrier application displays an indication of the switch request on the GUI of the second user device 124, at 534. The indication includes the offer price and may include information (e.g., flight number, departure time, arrival time, seat number, other information, or a combination thereof) associated with the ticket of the first user 202.

In the illustrated example, the second instance 126 receives an indication of acceptance of the switch request, at 538. For example, the second user 204 may select a GUI element indicating acceptance. It should be noted that in other examples, the second instance 126 of the carrier application may receive a counteroffer or a refusal rather than the indication of acceptance. In response to the indication of acceptance, the second instance 126 of the carrier application transmits an acceptance message to the first instance 122 of the carrier application, at 538. The acceptance message may include information identifying a ticket or account of the second user 204 (e.g., a reservation number, a user account identifier, a financial account identifier, etc.).

Based on the acceptance message, the first instance 122 of the carrier application sends one or more messages to initiate one or more financial transactions at the one or more financial devices 150, at 540. The one or more financial transactions include transferring the offer price from an account of the first user 202 to an account of the second user 204. The one or more financial transactions may further include transferring a fee (e.g., a flat fee or a percentage of the offer price) from an account of the first user 202 to an account of an airline associated with the tickets of the users 202, 204. In response to receiving confirmation of the one or more financial transitions, at 542, the first instance 122 of the carrier application sends one or more messages to the ticketing service 144 instructing the ticketing service to exchange the tickets of the users 202, 204. While not illustrated, the ticketing service 144 may send a confirmation message to the first instance 122 of the carrier application that the first instance 122 of the carrier application may relay to the second instance 126 of the carrier application. The instances 122, 126 may update their respective GUIs based on the confirmation message from the ticketing service 144.

Thus, FIG. 7 illustrates an example in which instances of the carrier application may communicate directly to coordinate exchange of tickets. In other examples, operations may be distributed amongst components of the system 100 differently. Further, the examples illustrated in any of FIGS. 2-6 may be modified to incorporate direct communication between instances of the carrier application as illustrated in FIG. 7.

The system 100 to exchange tickets between passengers may support additional functionality. For example, in some implementations, the system 100 supports the first instance 122 of the carrier application transmitting a request to a ticket without including an offer price. In such implementations, a recipient (e.g., the second instance 126 of the carrier application) of the request may transmit an offer price to the first instance 122 of the carrier application that the first instance 122 of the carrier application may accept or reject.

Further, in some implementations, the system 100 is configured to facilitate exchange of tickets between passengers of a single flight. For example, the first instance 122 of the carrier application may receive user input from the first user 202 requesting to change to a different seat on a flight. The first instance 122 of the carrier application may obtain an offer price and communicate with the second instance 126 of the carrier application as described above to present the offer price to the second user 204 and arrange a ticket exchange. Similarly, the second instance 126 of the carrier application may retrieve a ticket marketplace information that includes tickets for a flight that the second user 204 has a ticket.

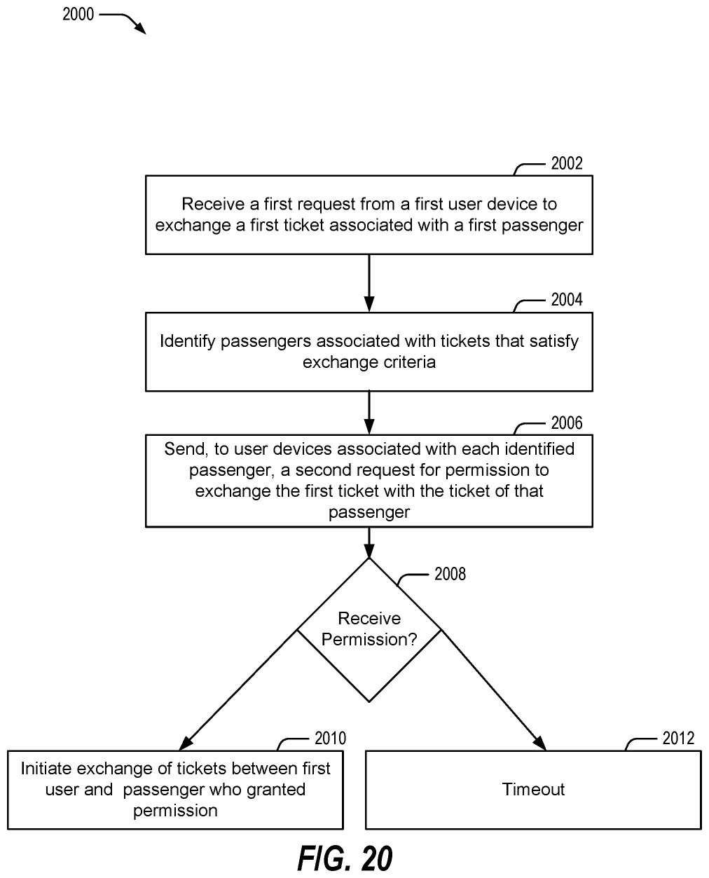

Referring to FIG. 20, a flowchart illustrating a method 2000 of exchanging tickets between passengers is shown. The method 2000 may be performed by the one or more carrier devices 130. In particular, the method 2000 may be performed by the application service 142 executed by the one or more carrier devices 130.

The method 2000 includes receiving a first request from a first user device to exchange a first ticket associated with a first passenger, at 2002. For example, the application service 142 may receive a request to exchange a first ticket of the first user 202, as shown at 228 of FIG. 2. The first request to exchange the first ticket may include exchange criteria (e.g., a flight number, a seating classification, such as first class, or other criteria) and an offer price. In some implementations, the method 2000 includes identifying available flights based on government regulations and information associated with the first ticket. For example, in response to a request for available flights from the first instance 122 of the carrier application, the application service 142 may identify flights that satisfy TSA regulations related to ticket exchanges. The method 2000 may include transmitting the identified available flights to the first user device and receiving the exchange criteria including a selection of one of the identified available flights as part of the first request.

The method 2000 further includes identifying passengers associated with tickets that satisfy exchange criteria, at 2004. For example, the first request to exchange the first ticket may include exchange criteria specifying a particular flight number. Accordingly, the application service 142 may identify passengers (e.g., the second user 204) who have tickets for the particular flight number. In some examples, the application service 142 maintains a database indicating users who have opted into a ticket exchange service. The application service 142 may identify passengers who have tickets that satisfy the exchange criteria and are included in the database.

The method 2000 further includes sending, to each identified passenger, a second request for permission to exchange the first ticket with the ticket of that passenger, at 2006. For example, the application service 142 may send a request for permission to exchange the first ticket of the first user 202 with a second ticket of the second user 204, as depicted at 229 of FIG. 2.

The method 2000 further includes determining whether permission has been received, at 2008. In response to receiving permission, the method 2000 includes initiating exchange of tickets between the first user and the passenger who granted permission, at 2010. For example, the application service may initiate exchange of the first ticket from the first user 202 to the second user 204 and initiate exchange of the second ticket from the second user 204 to the first user 202, as depicted at 248 of FIG. 2. In some examples, first request may indicate an offer price and the method 2000 may include initiating transfer of the offer price from an account of the first user 202 to an account of the accepting user (e.g., the second user 204) in response receiving the permission, as shown at 244 of FIG. 2. Initiating exchange of the first ticket may be contingent on confirmation of the transfer of the offer price.

In response to receiving no permission within a timeout period, the method 2000 includes timing out at 2012. For example, if no instance of the carrier application accepts a request for permission to exchange the first ticket, the application service 142 may terminate an attempt to exchange the first ticket. In such cases, the method 2000 may include sending a notification to the first user device that the first request has been rejected.

Thus, the method 2000 may be used to exchange tickets between users. Accordingly, the method 2000 may provide for a more convenient travel experience.

Referring to FIG. 21 a block diagram of a computer system 2100 that may change travel reservations according to the techniques described herein. The computer system 2100 includes a computing device 2102. The computing device 2102 may correspond to the first user device 120, the second user device 124, the one or more financial devices 150, the one or more carrier devices 130, or a combination thereof. The computing device 2102 includes one or more processors 2104 and one or more computer readable storage devices 2106. The one or more processors 2104 may include one or more CPUs, one or more GPUs, one or more other processors, or a combination thereof. The one or more computer readable storage devices 2106 may include one or more read only memory (ROM) devices, one or more random access memory (RAM) devices, one or more disc drive devices, one or more other types of memory devices, or a combination thereof. The one or more computer readable storage devices 2106 store ticketing instructions 2108 that are executable by the one or more processors 2104 to perform one or more of the functions described herein. For example, the ticketing instructions 2108 may correspond to the first instance 122 of the carrier application, the second instance 126 of the carrier application, the application service 142, the ticketing service 144, or a combination thereof. The ticketing instructions 2108 may be executable by the one or more processors 2104 to perform operations described herein with respect to FIGS. 1-20. In particular, the ticketing instructions 2108 may be executable by the one or more processors 2104 to exchange tickets between users according to the techniques and methods described herein.

The computing device 2102 further includes one or more network interface 2110. The one or more network interfaces 2110 include a wired interface (e.g., an ethernet interface), a wireless interface (e.g., an institute of Electrical and Electronics Engineers 802.11 interface), or a combination thereof. The computing device 2102 is configured to send and receive messages through a network, such as the public network 128, via the one or more network interfaces 2110 in response to execution of the ticketing instructions 2108.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations may be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). The use of the term “about” means±10% of the subsequent number, unless otherwise stated.

Use of the term “optionally” with respect to any element of a claim means that the element is required, or alternatively, the element is not required, both alternatives being within the scope of the claim. Use of broader terms such as comprises, includes, and having may be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present disclosure.

It is to be understood that the above description is intended to be illustrative, and not restrictive. For example, the above-described embodiments may be used in combination with each other. Many other embodiments will be apparent to those of skill in the art upon reviewing the above description. The scope of the invention therefore should be determined with reference to the appended claims, along with the full scope of equivalents to which such claims are entitled. It should be noted that the discussion of any reference is not an admission that it is prior art to the present invention, especially any reference that may have a publication date after the priority date of this application.

What is claimed is:

1. A method comprising:
receiving, at a first user device executing a first instance of an application, first user input requesting exchange of a first ticket associated with a first passenger;
sending, from the first user device to a server, a first request to exchange the first ticket;
receiving, at the server, the first request;
identifying, at the server, a second passenger associated with a second ticket based on exchange criteria;
sending, from the server to a second user device executing a second instance of the application, a second request for permission to exchange the first ticket with the second ticket, the second user device associated with the second passenger;
displaying, at the second user device an indication of the second request for permission to exchange the first ticket with the second ticket;
receiving, at the second user device, second user input indicating permission to exchange the first ticket with the second ticket;
sending, from the second user device to the server, an indication of the permission to exchange the first ticket with the second ticket; and
in response to receiving, at the server, the indication of the permission, sending a third request to a ticketing system to change the first ticket from the first passenger to the second passenger and to change the second ticket from the second passenger to the first passenger.

2. The method of claim 1, wherein the exchange criteria include a selected flight number.

3. The method of claim 2, further comprising:
identifying, at the server, available flights based on government regulations and information associated with the first ticket;
transmitting, from the server, indications of the available flights to the first user device; and
receiving, at the server, the selected flight number from the first user device.

4. The method of claim 1, wherein the exchange criteria include a seating classification.

5. The method of claim 1, wherein the first request and the second request identify an offer price.

6. The method of claim 5, further comprising initiating transfer of the offer price from an account of the first passenger to an account of the second passenger in response to receiving the permission from the second user device.

7. The method of claim 1, further comprising:
identifying, at the server, a plurality of passengers associated with a plurality of tickets based on the exchange criteria; and
sending, from the server, the second request to a plurality of user devices associated with the plurality of passengers.

8. The method of claim 1, further comprising receiving, at the server, a fourth request to opt the second passenger into a ticket exchange service, wherein the second passenger is identified, at the server, based further on the fourth request to opt the second passenger into the ticket exchange service.

9. One or more computer readable storage devices storing instructions executable by one or more processors to:
receive, at a first user device executing a first instance of an application, first user input requesting exchange of a first ticket associated with a first passenger;
send, from the first user device to a server, a first request to exchange the first ticket;
receive, at the server, the first request;
identify, at the server, a second passenger associated with a second ticket based on exchange criteria;
send, from the server to a second user device executing a second instance of the application, a second request for permission to exchange the first ticket with the second ticket, the second user device associated with the second passenger;
display, at the second user device an indication of the second request for permission to exchange the first ticket with the second ticket;
receive, at the second user device, second user input indicating permission to exchange the first ticket with the second ticket;
send, from the second user device to the server, an indication of the permission to exchange the first ticket with the second ticket; and
in response to receiving, at the server, the indication of the permission, send a third request to a ticketing system to change the first ticket from the first passenger to the second passenger and to change the second ticket from the second passenger to the first passenger.

10. The one or more computer readable storage devices of claim 9, wherein the exchange criteria include a selected flight number.

11. The one or more computer readable storage devices of claim 10, wherein the instructions are further executable by the one or more processors to:
identify, at the server, available flights based on government regulations and information associated with the first ticket;
transmit, from the server, indications of the available flights to the first user device; and
receive, at the server, the selected flight number from the first user device.

12. The one or more computer readable storage devices of claim 9, wherein the exchange criteria include a seating classification.

13. The one or more computer readable storage devices of claim 9, wherein the first request and the second request identify an offer price.

14. The one or more computer readable storage devices of claim 13, wherein the instructions are further executable by the one or more processors to send, from the server to a financial system, a fourth request to transfer the offer price from an account of the first passenger to an account of the second passenger in response to receiving the indication of the permission from the second user device.

15. The one or more computer readable storage devices of claim 9, wherein the instructions are further executable by the one or more processors to:
identify, at the server, a plurality of passengers associated with a plurality of tickets based on the exchange criteria; and
send, from the server, the second request to a plurality of user devices associated with the plurality of passengers.

16. The one or more computer readable storage devices of claim 9, wherein the instructions are further executable by the one or more processors to receive, at the server, a fourth request to opt the second passenger in to a ticket exchange service, wherein the second passenger is identified, at the server, based further on the fourth request to opt the second passenger in to the ticket exchange service.

17. A system including:
one or more processors; and
one or more memory devices storing computer readable instructions executable by the one or more processors to:
receive, at a first user device executing a first instance of an application, first user input requesting exchange of a first ticket associated with a first passenger;
send, from the first user device to a server, a first request to exchange the first ticket;
receive, at the server, the first request;
identify, at the server, a second passenger associated with a second ticket based on exchange criteria;
send, from the server to a second user device executing a second instance of the application, a second request for permission to exchange the first ticket with the second ticket, the second user device associated with the second passenger;
display, at the second user device an indication of the second request for permission to exchange the first ticket with the second ticket;
receive, at the second user device, second user input indicating permission to exchange the first ticket with the second ticket;
send, from the second user device to the server, an indication of the permission to exchange the first ticket with the second ticket; and
in response to receiving, at the server, the indication of the permission, send a third request to a ticketing system to change the first ticket from the first passenger to the second passenger and to change the second ticket from the second passenger to the first passenger.

18. The system of claim 17, wherein the exchange criteria include a selected flight number.

19. The system of claim 18, wherein the instructions are further executable by the one or more processors to:
identify, at the server, available flights based on government regulations and information associated with the first ticket;
transmit, from the server, indications of the available flights to the first user device; and
receive, at the server, the selected flight number from the first user device.

20. The apparatus of claim 17, wherein the exchange criteria include a seating classification.
